(19) United States
(12) Patent Application Publication
(10) Pub. No.: US 2025/0084899 A1
(43) Pub. Date: Mar. 13, 2025

(54) AIR CYCLE MACHINE (ACM) WITH HYBRID AIRFOIL AND AUXILIARY MAGNETIC THRUST BEARINGS

(71) Applicant: Hamilton Sundstrand Corporation, Charlotte, NC (US)

(72) Inventors: Viktor Kilchyk, Lancaster, NY (US); Brent J. Merritt, Southwick, MA (US)

(21) Appl. No.: 18/464,957

(22) Filed: Sep. 11, 2023

(51) Int. Cl. F16C 32/04; F04D 29/057; F04D 29/058; F16C 17/04

(52) U.S. Cl. CPC F16C 32/0402; F04D 29/057; F04D 29/058; F16C 17/042; F16C 32/0427; F16C 2360/44

(57) ABSTRACT

A hybrid airfoil thrust bearing is provided for a shaft including a thrust disc that rotates with the shaft. The hybrid airfoil thrust bearing includes airfoil bearing components and passive magnetic bearing components. The hybrid airfoil bearing components include a first top foil immediately adjacent to a first side of the thrust disc and surrounding the shaft, first additional components, a second top foil immediately adjacent to a second side of the thrust disc and surrounding the shaft and second additional components. The passive magnetic bearing components are integrated into the thrust disc and into the first and second additional components to remove a static load of the thrust disc on the first top foil and on the second top foil.

### BACKGROUND

The present disclosure relates to air cycle machines (ACMs) and, in particular, to an ACM with hybrid airfoil and passive magnetic thrust bearings.

A foil bearing, also known as a foil-air bearing or airfoil bearing, is a type of air bearing. A shaft is supported by a compliant, spring-loaded foil journal lining. Once the shaft is spinning fast enough, the working fluid (usually air) pushes the foil away from the shaft so that no contact occurs. The shaft and foil are separated by high-pressure air, which is generated by the rotation that pulls gas into the bearing via viscosity effects. The high speed of the shaft with respect to the foil is required to initiate the air gap, and once this has been achieved, no wear occurs. Unlike aerostatic or hydrostatic bearings, foil bearings require no external pressurization system for the working fluid, so the hydrodynamic bearing is self-starting.

### SUMMARY

According to an aspect of the disclosure, a hybrid airfoil thrust bearing is provided for a shaft including a thrust disc that rotates with the shaft. The hybrid airfoil thrust bearing includes airfoil bearing components and passive magnetic bearing components. The hybrid airfoil bearing components include a first top foil immediately adjacent to a first side of the thrust disc and surrounding the shaft, first additional components, a second top foil immediately adjacent to a second side of the thrust disc and surrounding the shaft and second additional components. The passive magnetic bearing components are integrated into the thrust disc and into the first and second additional components to remove a static load of the thrust disc on the first top foil and on the second top foil.

In accordance with additional or alternative embodiments, the first additional components include a first thrust bearing defining a first bore and a first bump foil axially interposed between the first top foil and the first thrust bearing, the second additional components include a second thrust bearing defining a second bore and a second bump foil axially interposed between the second top foil and the second thrust bearing and the shaft is rotatable about a longitudinal axis thereof within the first and second bores and relative to the first and second thrust bearings.

In accordance with additional or alternative embodiments, the passive magnetic bearing components include passive magnetic materials integrated into the thrust disc and passive magnetic materials integrated into the first and second thrust bearings and having a same polarity as the passive magnetic materials integrated into the thrust disc.

In accordance with additional or alternative embodiments, the passive magnetic bearing components include first and second passive magnetic materials of opposite polarity integrated into the first and second sides of the thrust disc, third passive magnetic materials of a same polarity as the first passive magnetic materials integrated into the first thrust bearing and fourth passive magnetic materials of a same polarity as the second passive magnetic materials integrated into the second thrust bearing.

In accordance with additional or alternative embodiments, the first additional components include a first thrust bearing defining a first bore, a first bump foil axially interposed between the first top foil and the first thrust bearing and a first flange outboard of the first top foil and affixed to an outboard edge of the first thrust bearing, the second additional components include a second thrust bearing defining a second bore, a second bump foil axially interposed between the second top foil and the second thrust bearing and a second flange outboard of the second top foil and affixed to an outboard edge of the second thrust bearing and the shaft is rotatable about a longitudinal axis thereof within the first and second bores and relative to the first and second thrust bearings.

In accordance with additional or alternative embodiments, the passive magnetic bearing components include passive magnetic materials integrated into the thrust disc and passive magnetic materials integrated into the first and second flanges and having a same polarity as the passive magnetic materials integrated into the thrust disc.

In accordance with additional or alternative embodiments, the passive magnetic bearing components include first and second passive magnetic materials of opposite polarity integrated into the first and second sides of the thrust disc, third passive magnetic materials of a same polarity as the first passive magnetic materials integrated into the first flange and fourth passive magnetic materials of a same polarity as the second passive magnetic materials integrated into the second flange.

According to an aspect of the disclosure, a device is provided and includes a shaft rotatable about a longitudinal axis thereof, a thrust disc disposed along the shaft to rotate with the shaft and a hybrid airfoil thrust bearing. The hybrid airfoil thrust bearing includes airfoil bearing components and passive magnetic bearing components. The airfoil bearing components include a first top foil immediately adjacent to a first side of the thrust disc and surrounding the shaft, first additional components, a second top foil immediately adjacent to a second side of the thrust disc and surrounding the shaft and second additional components. The passive magnetic bearing components are integrated into the thrust disc and into the first and second additional components to remove a static load of the thrust disc on the first top foil and on the second top foil.

In accordance with additional or alternative embodiments, a turbine wheel is connected to a first end of the shaft, a compressor wheel is connected to a second end of the shaft and one or more journal bearings is disposed along at least one of the first and second ends of the shaft.

In accordance with additional or alternative embodiments, the one or more journal bearings is a hybrid airfoil bearing.

In accordance with additional or alternative embodiments, the first additional components include a first thrust bearing defining a first bore and a first bump foil axially interposed between the first top foil and the first thrust bearing, the second additional components include a second thrust bearing defining a second bore and a second bump foil axially interposed between the second top foil and the second thrust bearing and the shaft is rotatable about a longitudinal axis thereof within the first and second bores and relative to the first and second thrust bearings.

In accordance with additional or alternative embodiments, the passive magnetic bearing components include passive magnetic materials integrated into the thrust disc and passive magnetic materials integrated into the first and second thrust bearings and having a same polarity as the passive magnetic materials integrated into the thrust disc.

In accordance with additional or alternative embodiments, the passive magnetic bearing components include first and second passive magnetic materials of opposite polarity integrated into the first and second sides of the thrust disc, third passive magnetic materials of a same polarity as the first passive magnetic materials integrated into the first thrust bearing and fourth passive magnetic materials of a same polarity as the second passive magnetic materials integrated into the second thrust bearing.

In accordance with additional or alternative embodiments, the first additional components include a first thrust bearing defining a first bore, a first bump foil axially interposed between the first top foil and the first thrust bearing and a first flange outboard of the first top foil and affixed to an outboard edge of the first thrust bearing, the second additional components include a second thrust bearing defining a second bore, a second bump foil axially interposed between the second top foil and the second thrust bearing and a second flange outboard of the second top foil and affixed to an outboard edge of the second thrust bearing and the shaft is rotatable about a longitudinal axis thereof within the first and second bores and relative to the first and second thrust bearings.

In accordance with additional or alternative embodiments, the passive magnetic bearing components include passive magnetic materials integrated into the thrust disc and passive magnetic materials integrated into the first and second flanges and having a same polarity as the passive magnetic materials integrated into the thrust disc.

In accordance with additional or alternative embodiments, the passive magnetic bearing components include first and second passive magnetic materials of opposite polarity integrated into the first and second sides of the thrust disc, third passive magnetic materials of a same polarity as the first passive magnetic materials integrated into the first flange and fourth passive magnetic materials of a same polarity as the second passive magnetic materials integrated into the second flanges.

According to an aspect of the disclosure, an air cycle machine (ACM) is provided and includes a motor, an impeller, a shaft which is rotatable about a longitudinal axis thereof and by which the motor drives impeller rotation, a thrust disc disposed along the shaft to rotate with the shaft and a hybrid airfoil thrust bearing. The hybrid airfoil thrust bearing includes airfoil bearing components and passive magnetic bearing components. The airfoil bearing components include a first top foil immediately adjacent to a first side of the thrust disc and surrounding the shaft, first additional components, a second top foil immediately adjacent to a second side of the thrust disc and surrounding the shaft and second additional components. The passive magnetic bearing components are integrated into the thrust disc and into the first and second additional components to remove a static load of the thrust disc on the first top foil and on the second top foil.

In accordance with additional or alternative embodiments, passive magnetic repulsion between the passive magnetic bearing components integrated into the thrust disc and the passive magnetic bearing components integrated into the first and second additional components maintain an axial position of the thrust disc between the motor and the impeller.

In accordance with additional or alternative embodiments, one or more journal bearings is disposed along the shaft.

In accordance with additional or alternative embodiments, the one or more journal bearings is a hybrid airfoil bearing.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1A is a schematic side view of a hybrid airfoil bearing with axial segmentation in accordance with embodiments;

FIG. 1B is a cross-sectional view of the hybrid airfoil bearing with the axial segmentation taken along line A-A of FIG. 1A in accordance with embodiments;

FIG. 1C is an illustration of magnetic flux lines of the hybrid airfoil bearing with the axial segmentation of FIG. 1A in accordance with embodiments;

FIG. 2A is a schematic side view of a hybrid airfoil bearing with a radial configuration in accordance with embodiments;

FIG. 2B is a cross-sectional view of the hybrid airfoil bearing with the radial configuration taken along line A-A of FIG. 2A in accordance with embodiments;

FIG. 3 is a side view of an aviation motor including hybrid airfoil bearings in accordance with embodiments;

FIG. 4 is a side view of an air cycle machine (ACM) including axially arranged hybrid airfoil bearings in accordance with embodiments;

FIG. 5 is a side view of an air cycle machine (ACM) including radially arranged hybrid airfoil and passive magnetic bearings in accordance with embodiments; and

FIG. 6 is a schematic side view of a hybrid airfoil thrust bearing in accordance with embodiments;

FIG. 7 is a side view of a device including a hybrid airfoil thrust bearing in accordance with embodiments;

FIG. 8 is a side view of a device including a hybrid airfoil thrust bearing in accordance with embodiments; and

FIG. 9 is a side view of an ACM including a hybrid airfoil thrust bearing in accordance with embodiments.

### DETAILED DESCRIPTION

Airfoil bearings have certain limitations. These include a minimum speed to activate, sensitivity to damage due to metal-to-metal contact and/or inadequate thermal management. Active magnetic bearings resolve many of these issues, but have added cost and weight as well as a need for circuitry to provide current for the electromagnet.

Thus, as will be described below, a new type of hybrid airfoil bearing is provided. The hybrid airfoil bearing includes airfoil bearing components and permanent (or passive) magnetic bearing components. The magnetic bearing component use non-controllable repulsion force to improve bearing capacity and reliability. The magnetized components can be incorporated into airfoil components, such as a sleeve and a shaft. In addition, as will be described below, the hybrid airfoil bearing described herein can be installed in an ACM.

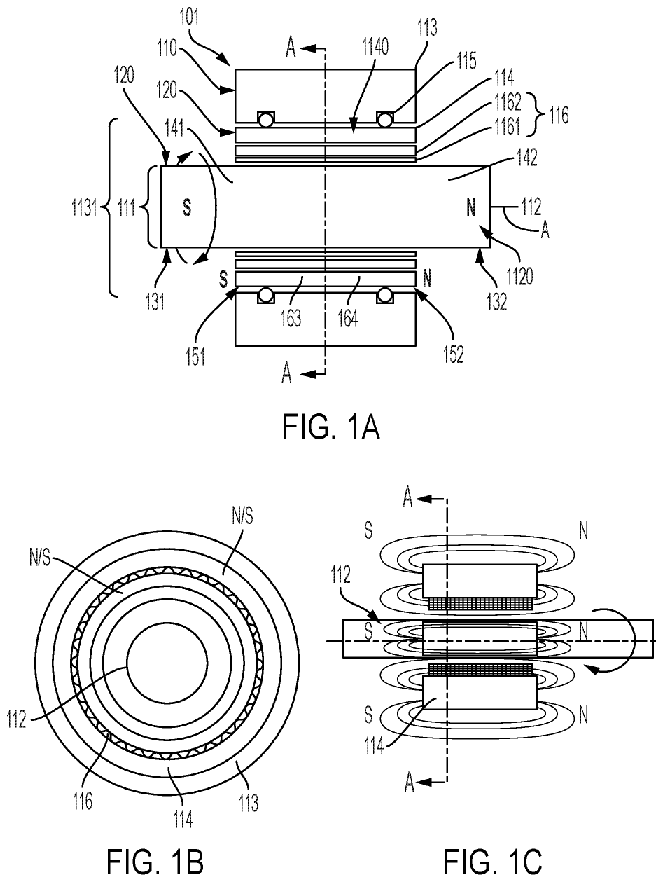

With reference to FIGS. 1A, 1B and 1C, a hybrid airfoil bearing 101 is provided for use with a shaft 112. The hybrid airfoil bearing 101 includes airfoil bearing components 110 and passive magnetic bearing components 120 that are integrated into the shaft 112 and the airfoil bearing components 110. The passive magnetic bearing components 120 can include or be provided with magnetic material that tends to retain its magnetic characteristics during high-temperature and high-pressure operations associated with aviation motors of an aircraft and air cycle machines (ACMs). that are integrated into the shaft 112 and the airfoil bearing components 110 The airfoil bearing components 110 include a top foil 1161 (see below) that immediately surrounds the shaft 112 and stationary components that define an inner bore 111. The shaft 112 is rotatable about a longitudinal axis A thereof within the inner bore 111 and relative to the stationary components. The stationary components include a housing 113, such as a motor housing, that defines an outer bore 1131 and a bearing sleeve 114 that is supported within the outer bore 1131. The stationary components further include elastomeric O-rings 115, by which the bearing sleeve 114 is supported within the outer bore 1131, and one or more foils 116 for supporting the shaft 112. The one or more foils 116 include the top foil 1161 and a corrugated bump foil 1162 surrounding the top foil 1161. With the top foil 1161 immediately surrounding the shaft 112, the bump foil 1162 immediately surrounds the top foil 1161. The one or more foils 116 can each include or be provided with high magnetic permeability materials. Additionally or alternatively, the one or more foils 116 can each be provided as a mesh.

The stationary components can also include one more filters that prevent particles, such as magnetic particles, from becoming trapped in the hybrid airfoil bearing 101.

During operation of the airfoil bearing components, if not for the presence of the passive magnetic bearing components 120, the shaft 112 would be supported as a static load by the one or more foils 116 (i.e., the top foil 1161) until the shaft 112 begins spinning or rotating fast enough for working fluid (i.e., air) to push the shaft 112 away from the one or more foils 116 so that no contact occurs. The initial contact between the shaft 112 and the one or more foils 116 (i.e., the static load of the shaft 112 on the top foil 1161) as well as the possibility of a loss of pressure of the working fluid during high-speed rotation of the shaft 112 can lead to wear and damage of the airfoil bearing components 110.

The passive magnetic bearing components 120 serve as auxiliary magnetic bearings to remove the static load of the shaft 112 on the top foil 1161 and to provide for auxiliary rotor or shaft support and emergency operation backup. For example, in case of a temporary loss of capacity due to low-speed rotation, rotor imbalance (surging), etc., the passive magnetic bearing components 120 would eliminate or reduce the chances of unit damage due to failure of the airfoil bearing components 110 maintaining separation of the shaft 112 and at least the top foil 1161 of the one or more foils 116. The passive magnetic bearing components 120 generate a repulsion force between the shaft 112 and at least the top foil 1161 of the one or more foils 116. This repulsion force is proportional to an inverse of a distance between the respective bearing surfaces of the shaft 112 and at least the top foil 1161 of the one or more foils 116 and becomes significant when the shaft 112 deviates from its centered (axial and/or radial) location.

In addition, since the passive magnetic bearing components 120 are integrated into the shaft 112 and the airfoil bearing components 110, the hybrid airfoil bearing 101 can be manufactured easily and without extensive additional costs.

With continued reference to FIGS. 1A, 1B and 1C, the shaft 112 can be provided as an elongate dipole magnet 1120 with a first end 131 and a second end 132 that is opposite the first end 131. At the first end 131, the shaft 112 includes first magnetic materials 141 having a first magnetic pole. At the second end 132, the shaft 112 includes second magnetic materials 142 having a second magnetic pole, which is opposite the first magnetic pole. At least one of the stationary components, such as the bearing sleeve 114 (for purposes of clarity and brevity, the following description will relate to the case in which the at least one of the stationary components is the bearing sleeve 114), can be provided as an elongate dipole magnet 1140 that surrounds the shaft 112 with a first end 151 corresponding to the first end 131 and a second end 152, which is opposite the first end 151 and corresponds to the second end 132. At the first end 151, the bearing sleeve 114 includes third magnetic materials 163 having the first magnetic pole. At the second end 152, the bearing sleeve 114 includes fourth magnetic materials 164 having the second magnetic pole. With this configuration, passive magnetic repulsion of the first magnetic materials 141 and the third magnetic materials 163 and passive magnetic repulsion of the second magnetic materials 142 and the fourth magnetic materials 164 suspends the shaft 112 within the inner bore 111 and maintains separation between the shaft 112 and both the bearing sleeve 114 and the one or more foils 116.

With the shaft 112 being provided as the elongate dipole magnet 1120, the description provided herein is distinguished from conventional cases in which an elongate dipole magnet is attached to or about a shaft. That is, in those conventional cases, passive magnetic components are not integrated into a shaft whereas in the description provided herein the passive magnet components 120 are integrated into the shaft 112 to form the shaft 112 into the elongate dipole magnet 1120.

It is to be understood that additional magnetic materials can be added to an exterior of the shaft 112, but not to the exclusion of passive magnetic materials being integrated into the shaft 112 as described above. It is to be further understood that the passive magnetic materials integrated into the shaft 112 and the bearing sleeve 114 need not be uniformly distributed throughout the shaft 112 or the bearing sleeve 114, particularly in the circumferential dimension. For example, the passive magnetic materials in the shaft 112 and the bearing sleeve 114 can be segmented along an entirety of the circumferential dimension of the shaft 112 and the bearing sleeve 114 and/or localized at one or more circumferential sections of the shaft 112 and the bearing sleeve 114 so that when the shaft 112 comes to rest, the one or more circumferential sections of the shaft 112 and the bearing sleeve 114 align in the vertical direction and remove the load of the shaft 112 on the one or more foils 116 in opposition to the force of gravity.

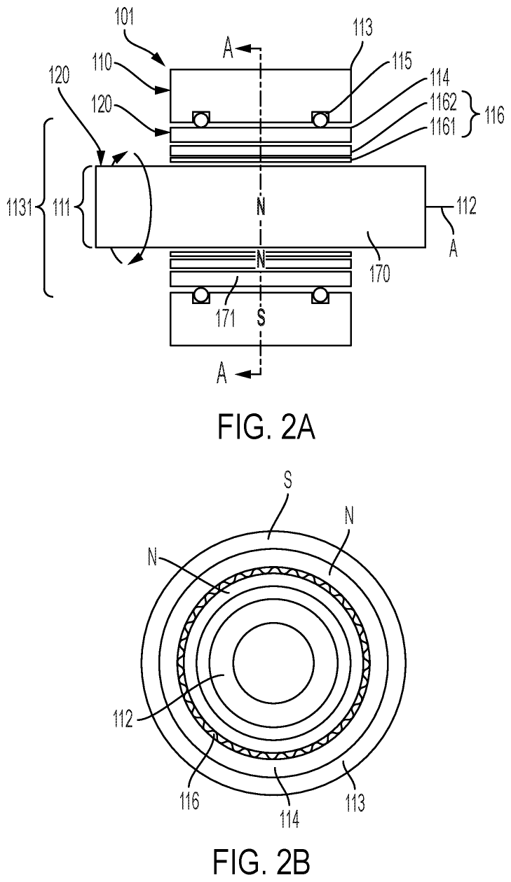

With reference to FIGS. 2A and 2B, the hybrid airfoil bearing 101 is provided with a similar overall configuration as the configuration described above but with a different passive magnetic arrangement. The following description will thus omit the details of the hybrid airfoil bearing 101 of FIGS. 2A and 2B that are already described above.

In FIGS. 2A and 2B, the shaft 112 includes an outer ring of magnetic materials 170 integrated therein and having a first magnetic pole and optionally an inner core of magnetic materials having a second magnetic pole and the bearing sleeve 114 includes an inner ring of magnetic materials 171 having the first magnetic pole and an outer ring of magnetic materials having the second magnetic pole. In this case, passive magnetic repulsion of the outer ring of magnetic materials 171 and the inner ring of magnetic materials 170 suspends the shaft 112 within the inner bore 111 and maintains separation between the shaft 112 and both the bearing sleeve 114 and the one or more foils 116. The shaft 112 can further include a hollow interior within the outer ring of magnetic materials 170 or an inner ring of magnetic materials that is either of a same pole as the outer ring of magnetic materials 170 or an opposite pole as the outer ring of magnetic materials 170. In any case, the shaft 112 does not include any portion formed of non-magnetic materials.

It is to be understood that additional magnetic materials can be added to an exterior of the shaft 112, but not to the exclusion of passive magnetic materials being integrated into the shaft 112 as described above. It is to be further understood that the passive magnetic materials integrated into the shaft 112 and the bearing sleeve 114 need not be uniformly distributed throughout the shaft 112 or the bearing sleeve 114, particularly in the circumferential dimension. For example, the passive magnetic materials in the shaft 112 and the bearing sleeve 114 can be segmented along an entirety of the circumferential dimension of the shaft 112 and the bearing sleeve 114 and/or localized at one or more circumferential sections of the shaft 112 and the bearing sleeve 114 so that when the shaft 112 comes to rest, the one or more circumferential sections of the shaft 112 and the bearing sleeve 114 align in the vertical direction and remove the load of the shaft 112 on the one or more foils 116 in opposition to the force of gravity.

As above, with the shaft 112 including the outer ring of magnetic materials 170 integrated therein, the description provided herein is distinguished from conventional cases in which a ring of passive magnetic materials is attached to or about a shaft of non-magnetic materials. That is, in those conventional cases, passive magnetic components are not integrated into a shaft whereas in the description provided herein the outer ring of magnetic materials 170 are integrated into the shaft 112.

Thus, in general, the shaft 112 and both the bearing sleeve 114 and the one or more foils 116 are respectively configured for passive magnetic repulsion of one another to suspend the shaft 112 within the inner bore 111 and to act as an auxiliary bearing for the airfoil bearing components 110.

It is to be understood that the magnetic materials of the embodiments of FIGS. 1A, 1B and 1C and the magnetic materials of the embodiments of FIGS. 2A and 2B may exhibit variable magnetization in circumferential, axial and/or radial dimensions to accommodate and/or account for possible variable attitude angles of the hybrid airfoil bearing 101.

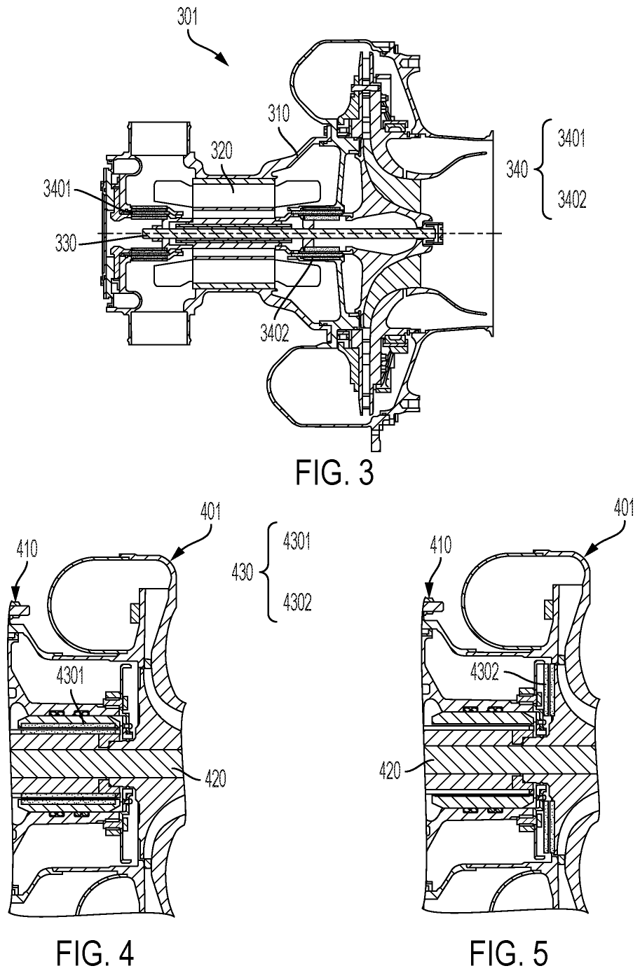

With reference to FIG. 3, a device 301 is provided as an aviation motor of an aircraft and includes a housing 310, a stator 320, a rotor 330 that is rotatable within the housing 310 and one or more hybrid airfoil bearings 340. The stator 320 is configured to generate magnetic flux to drive rotation of the rotor 330. The one or more hybrid airfoil bearings 340 can be provided as first and second hybrid airfoil bearings 3401 and 3402. Each of the first and second hybrid airfoil bearings 3401 and 3402 is configured as described above with reference to FIGS. 1A, 1B and 1C or FIGS. 2A and 2B.

With reference to FIGS. 4 and 5, a device 401 is provided as an ACM and includes a housing 410, a rotor 420 that is rotatable within the housing 410 and one or more hybrid airfoil bearings 430. The one or more hybrid airfoil bearings 430 can be provided as an axially oriented hybrid airfoil bearing 4301 (see FIG. 4) and a radially oriented hybrid airfoil bearing 4302 (see FIG. 5). Each of the axially oriented hybrid airfoil bearing 4301 and the radially oriented hybrid airfoil bearing 4302 is configured as described above with reference to FIGS. 1A, 1B and 1C or FIGS. 2A and 2B. In each case of the hybrid airfoil bearings 430 being used with an ACM, the various sleeves described above can be integrated into the ACM.

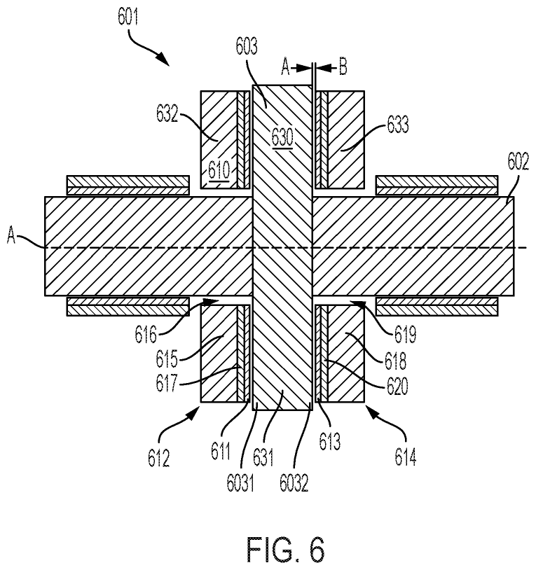

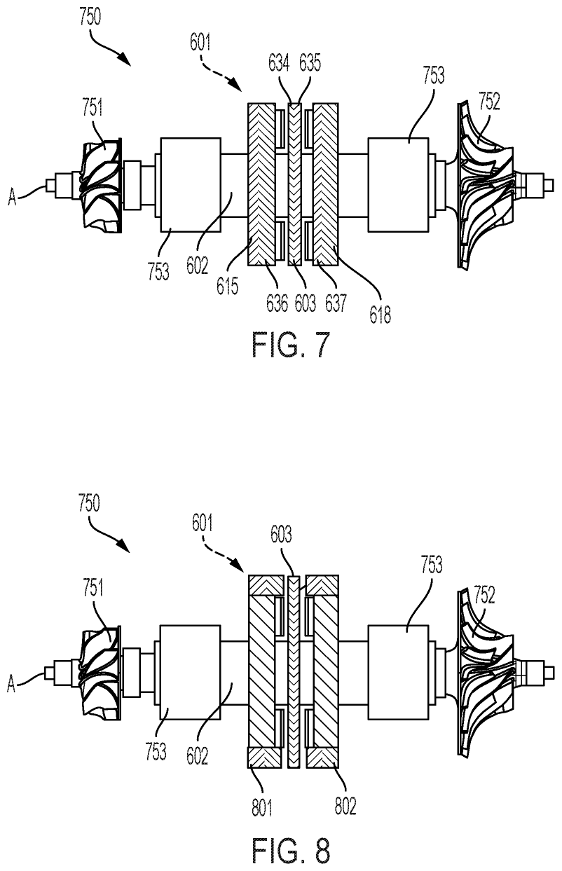

With reference to FIGS. 6 and 7, a hybrid airfoil thrust bearing 601 is provided for use with a shaft 602 that includes a thrust disc 603 that rotates with the shaft 602. The hybrid airfoil thrust bearing 601 generally operates in a similar manner as described above.

The hybrid airfoil thrust bearing 601 includes airfoil bearing components 610 and passive magnetic bearing components 630. The airfoil bearing components 610 include a first top foil 611 immediately adjacent to a first side 6031 of the thrust disc 603 at a distance A-B and surrounding the shaft 602, first additional components 612, a second top foil 613 immediately adjacent to a second side 6032 of the thrust disc 603 at the distance A-B and surrounding the shaft 602 and second additional components 614. The first additional components 612 can include a first thrust bearing 615 defining a first bore 616 and a first bump foil 617, which is axially interposed between the first top foil 611 and the first thrust bearing 615, and the second additional components 614 can include a second thrust bearing 618 defining a second bore 619 and a second bump foil 620, which is axially interposed between the second top foil 613 and the second thrust bearing 618. The shaft 602 is rotatable about a longitudinal axis A thereof within the first and second bores 616 and 619 and relative to the first and second thrust bearings 615 and 618. The passive magnetic bearing components 630 are integrated into the thrust disc 603 and into the first and second additional components 612 and 614 to maintain an axial location of the thrust disc 603 between the first and second top foils 611 and 613 and to thereby remove a static load of the thrust disc 603 on the first top foil 611 and on the second top foil 613.

In accordance with embodiments and as shown in FIG. 6, the passive magnetic bearing components 630 can include passive magnetic materials 631, which are integrated into the thrust disc 603, and passive magnetic materials 632 and 633, which are integrated into each of the first and second thrust bearings 615 and 618, respectively, and have a same polarity as the passive magnetic materials 631 integrated into the thrust disc 603. In this case, passive magnetic repulsion between the passive magnetic materials 631 and the passive magnetic materials 632 and passive magnetic repulsion between the passive magnetic materials 631 and the passive magnetic materials 633 cooperatively maintain the axial location of the thrust disc 603 between the first and second top foils 611 and 613.

In accordance with embodiments and as shown in FIG. 7, the passive magnetic bearing components 630 (see FIG. 6) can include first and second passive magnetic materials 634 and 635 of opposite polarity integrated into the first and second sides 6031 and 6032 of the thrust disc 603 (see FIG. 6), third passive magnetic materials 636 of a same polarity as the first passive magnetic materials 634 integrated into the first thrust bearing 615 and fourth passive magnetic materials 637 of a same polarity as the second passive magnetic materials 635 integrated into the second thrust bearing 618. In this case, passive magnetic repulsion between the first and third passive magnetic materials 634 and 636 and passive magnetic repulsion between the second and fourth passive magnetic materials 635 and 637 cooperatively maintain the axial location of the thrust disc 603 between the first and second top foils 611 and 613 (see FIG. 6).

With reference to FIG. 8, the first additional components 612 (see FIG. 6) can further include a first flange 801, which is outboard of the first top foil 611 and affixed to an outboard edge of the first thrust bearing 615 (see FIG. 6), and the second additional components 614 (see FIG. 6) can further include a second flange 802, which is outboard of the second top foil 613 and affixed to an outboard edge of the second thrust bearing 618 (see FIG. 6). In this case, the first and second flanges 801 and 802 can have passive magnetic materials integrated therein as in the embodiments of FIG. 6 or as in the embodiments of FIG. 7 (the embodiments of FIG. 8 correspond to the embodiments of FIG. 7; this is done for purposes of clarity and brevity and is not intended to otherwise limit the scope of this disclosure or the following claims) and passive magnetic repulsion(s) cooperatively maintain(s) the axial location of the thrust disc 603 between the first and second top foils 611 and 613 (see FIG. 6).

With continued reference to FIGS. 6, 7 and 8 and in accordance with embodiments, the various repulsive forces described herein can be equalized on either side of the thrust disc 603 or, in some cases, non-equalized (in a controlled or uncontrolled manner).

With continued reference to FIGS. 7 and 8, a device 750 is provided and includes the shaft 602, which is rotatable about the longitudinal axis A thereof, the thrust disc 603, which is disposed along the shaft 602 to rotate with the shaft 602, and a hybrid airfoil thrust bearing 601 as described above with reference to FIGS. 6 and 7 and with reference to FIG. 8. The device 750 can include a turbine wheel 751 connected to a first end of the shaft 602, a compressor wheel 752 connected to a second end of the shaft 602 and one or more journal bearings 753 disposed along at least one of the first and second ends of the shaft 602. In accordance with embodiments, the one or more journal bearings 753 can be provided as a hybrid airfoil bearing, such as the hybrid airfoil bearing 101 of FIGS. 1A, 1B and 1C or FIGS. 2A and 2B.

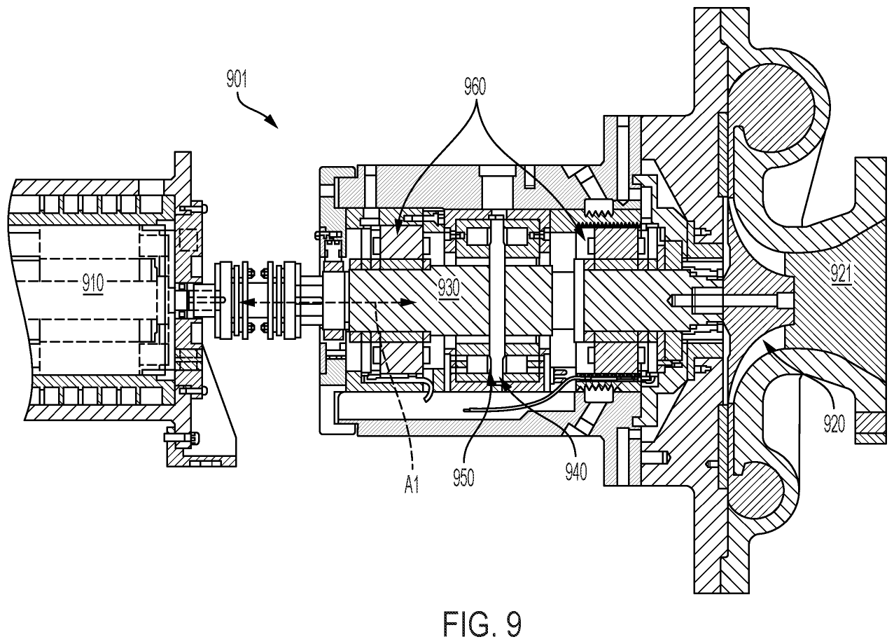

With reference to FIG. 9, an air cycle machine (ACM) 901 is provided and includes a motor 910, such as a high-speed motor, an impeller 920 with an inlet 921 and a rotor or shaft 930, which is rotatable about a longitudinal axis μl thereof and by which the motor 910 drives rotation of the impeller 920. The ACM 901 further includes a thrust disc 940, which is disposed along the shaft 930 to rotate with the shaft 930 and a hybrid airfoil thrust bearing 950. The hybrid airfoil thrust bearing 950 can be configured in a substantially similar manner as the hybrid airfoil thrust bearing 601 of FIGS. 6 and 7 and of FIG. 8. The passive magnetic repulsion between the passive magnetic bearing components integrated into the thrust disc 940 and the passive magnetic bearing components integrated into the first and second additional components of the hybrid airfoil thrust bearing 601 as described above maintain an axial position of the thrust disc 940 between the motor 910 and the impeller 920. The ACM 901 can further include one or more journal bearings 960 disposed along the shaft 930 and, in accordance with embodiments, the one or more journal bearings 960 can be provided as a hybrid airfoil bearing, such as the hybrid airfoil bearing 101 of FIGS. 1A, 1B and 1C or FIGS. 2A and 2B.

Technical effects and benefits of the present disclosure are the provision of a hybrid airfoil thrust bearing that offers improved operation below a critical speed, increased bearing capacity, reduced or eliminated metal-to-metal contact in case of bearing overloading (e.g., due to rotor icing), increased bearing and machine (e.g., aviation motor, air cycle machine (ACM), etc.) durability and lifetime and a minimum impact on weight and costs of the machine.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A hybrid airfoil thrust bearing for a shaft comprising a thrust disc that rotates with the shaft, the hybrid airfoil thrust bearing comprising:
airfoil bearing components comprising:
a first top foil immediately adjacent to a first side of the thrust disc and surrounding the shaft;
first additional components;
a second top foil immediately adjacent to a second side of the thrust disc and surrounding the shaft; and
second additional components; and
passive magnetic bearing components integrated into the thrust disc and into the first and second additional components to remove a static load of the thrust disc on the first top foil and on the second top foil.

2. The hybrid airfoil thrust bearing according to claim 1, wherein:
the first additional components comprise a first thrust bearing defining a first bore and a first bump foil axially interposed between the first top foil and the first thrust bearing,
the second additional components comprise a second thrust bearing defining a second bore and a second bump foil axially interposed between the second top foil and the second thrust bearing, and
the shaft is rotatable about a longitudinal axis thereof within the first and second bores and relative to the first and second thrust bearings.

3. The hybrid airfoil thrust bearing according to claim 2, wherein the passive magnetic bearing components comprise:
passive magnetic materials integrated into the thrust disc; and
passive magnetic materials integrated into the first and second thrust bearings and having a same polarity as the passive magnetic materials integrated into the thrust disc.

4. The hybrid airfoil thrust bearing according to claim 2, wherein the passive magnetic bearing components comprise:
first and second passive magnetic materials of opposite polarity integrated into the first and second sides of the thrust disc;
third passive magnetic materials of a same polarity as the first passive magnetic materials integrated into the first thrust bearing; and
fourth passive magnetic materials of a same polarity as the second passive magnetic materials integrated into the second thrust bearing.

5. The hybrid airfoil thrust bearing according to claim 1, wherein:
the first additional components comprise a first thrust bearing defining a first bore, a first bump foil axially interposed between the first top foil and the first thrust bearing and a first flange outboard of the first top foil and affixed to an outboard edge of the first thrust bearing,
the second additional components comprise a second thrust bearing defining a second bore, a second bump foil axially interposed between the second top foil and the second thrust bearing and a second flange outboard of the second top foil and affixed to an outboard edge of the second thrust bearing, and
the shaft is rotatable about a longitudinal axis thereof within the first and second bores and relative to the first and second thrust bearings.

6. The hybrid airfoil thrust bearing according to claim 5, wherein the passive magnetic bearing components comprise:
passive magnetic materials integrated into the thrust disc; and
passive magnetic materials integrated into the first and second flanges and having a same polarity as the passive magnetic materials integrated into the thrust disc.

7. The hybrid airfoil thrust bearing according to claim 5, wherein the passive magnetic bearing components comprise:
first and second passive magnetic materials of opposite polarity integrated into the first and second sides of the thrust disc;
third passive magnetic materials of a same polarity as the first passive magnetic materials integrated into the first flange; and
fourth passive magnetic materials of a same polarity as the second passive magnetic materials integrated into the second flange.

8. A device, comprising:
a shaft rotatable about a longitudinal axis thereof;
a thrust disc disposed along the shaft to rotate with the shaft; and
a hybrid airfoil thrust bearing, comprising:
airfoil bearing components comprising:
a first top foil immediately adjacent to a first side of the thrust disc and surrounding the shaft;
first additional components;
a second top foil immediately adjacent to a second side of the thrust disc and surrounding the shaft; and
second additional components; and
passive magnetic bearing components integrated into the thrust disc and into the first and second additional components to remove a static load of the thrust disc on the first top foil and on the second top foil.

9. The device according to claim 8, further comprising:
a turbine wheel connected to a first end of the shaft;
a compressor wheel connected to a second end of the shaft; and
one or more journal bearings disposed along at least one of the first and second ends of the shaft.

10. The device according to claim 9, wherein the one or more journal bearings is a hybrid airfoil bearing.

11. The device according to claim 8, wherein:
the first additional components comprise a first thrust bearing defining a first bore and a first bump foil axially interposed between the first top foil and the first thrust bearing,
the second additional components comprise a second thrust bearing defining a second bore and a second bump foil axially interposed between the second top foil and the second thrust bearing, and
the shaft is rotatable about a longitudinal axis thereof within the first and second bores and relative to the first and second thrust bearings.

12. The device according to claim 11, wherein the passive magnetic bearing components comprise:
passive magnetic materials integrated into the thrust disc; and
passive magnetic materials integrated into the first and second thrust bearings and having a same polarity as the passive magnetic materials integrated into the thrust disc.

13. The device according to claim 11, wherein the passive magnetic bearing components comprise:
first and second passive magnetic materials of opposite polarity integrated into the first and second sides of the thrust disc;
third passive magnetic materials of a same polarity as the first passive magnetic materials integrated into the first thrust bearing; and
fourth passive magnetic materials of a same polarity as the second passive magnetic materials integrated into the second thrust bearing.

14. The device according to claim 8, wherein:
the first additional components comprise a first thrust bearing defining a first bore, a first bump foil axially interposed between the first top foil and the first thrust bearing and a first flange outboard of the first top foil and affixed to an outboard edge of the first thrust bearing,
the second additional components comprise a second thrust bearing defining a second bore, a second bump foil axially interposed between the second top foil and the second thrust bearing and a second flange outboard of the second top foil and affixed to an outboard edge of the second thrust bearing, and
the shaft is rotatable about a longitudinal axis thereof within the first and second bores and relative to the first and second thrust bearings.

15. The device according to claim 14, wherein the passive magnetic bearing components comprise:
passive magnetic materials integrated into the thrust disc; and
passive magnetic materials integrated into the first and second flanges and having a same polarity as the passive magnetic materials integrated into the thrust disc.

16. The device according to claim 14, wherein the passive magnetic bearing components comprise:
first and second passive magnetic materials of opposite polarity integrated into the first and second sides of the thrust disc;
third passive magnetic materials of a same polarity as the first passive magnetic materials integrated into the first flange; and
fourth passive magnetic materials of a same polarity as the second passive magnetic materials integrated into the second flanges.

17. An air cycle machine (ACM), comprising:
a motor;
an impeller;
a shaft, which is rotatable about a longitudinal axis thereof and by which the motor drives impeller rotation;
a thrust disc disposed along the shaft to rotate with the shaft; and
a hybrid airfoil thrust bearing, comprising:
airfoil bearing components comprising:
a first top foil immediately adjacent to a first side of the thrust disc and surrounding the shaft;
first additional components;
a second top foil immediately adjacent to a second side of the thrust disc and surrounding the shaft; and
second additional components; and
passive magnetic bearing components integrated into the thrust disc and into the first and second additional components to remove a static load of the thrust disc on the first top foil and on the second top foil.

18. The ACM according to claim 17, wherein passive magnetic repulsion between the passive magnetic bearing components integrated into the thrust disc and the passive magnetic bearing components integrated into the first and second additional components maintain an axial position of the thrust disc between the motor and the impeller.

19. The ACM according to claim 17, further comprising one or more journal bearings disposed along the shaft.

20. The device according to claim 18, wherein the one or more journal bearings is a hybrid airfoil bearing.
